(19) United States
(12) Patent Application Publication
(10) Pub. No.: US 2026/0213800 A1
(43) Pub. Date: Jul. 23, 2026

(54) METHOD, NETWORK NODE, AND COMPUTER PROGRAM FOR DOWNLINK INTERFERENCE SUPPRESSION IN AN ACCESS NETWORK

(71) Applicant: Telefonaktiebolaget LM Ericsson (publ), Stockholm (SE)

(72) Inventors: Simon JÄRMYR, Skarpnäck (SE); Svante BERGMAN, Hägersten (SE); George JÖNGREN, Sundbyberg (SE)

(73) Assignee: Telefonaktiebolaget LM Ericsson (publ), Stockholm (SE)

(21) Appl. No.: 19/157,878

(22) PCT Filed: Feb. 20, 2023
(86) PCT No.: PCT/EP2023/054142

§ 371 Date: Aug. 19, 2025

(51) Int. Cl. H04B 7/0456

(52) U.S. Cl. CPC H04B 7/0456

(57) ABSTRACT

There is provided techniques for downlink interference suppression in an access network. The method is performed by a network node. The method comprises estimating an uplink inter-cell interference covariance matrix for UEs not served by the network node from signals as received from the UEs on a first set of antenna ports and for a selected mapping from the first set of antenna ports to a second set of antenna ports upon which the inter-cell interference covariance matrix is formed. The method comprises performing downlink interference suppression by using a precoder. The precoder is determined as a function of the inter-cell interference covariance matrix whilst treating the inter-cell interference covariance matrix as having a block-diagonal structure, with L>1 blocks.

### TECHNICAL FIELD

Embodiments presented herein relate to a method, a network node, a computer program, and a computer program product for downlink interference suppression in an access network.

### BACKGROUND

Transmit beamforming is a technique for controlling the radiated power, phase, and polarization of an antenna array in different directions. Several spatial layers—each with an associated beamforming vector—can be transmitted simultaneously in a spatial multiplexing transmission scheme for single-user (SU) multiple-input-multiple-output (MIMO) communication or for multiple-user (MU) MIMO communication. In the context of the downlink (DL) of a cellular communications network—with several network nodes (NNs) serving several user equipment (UEs)—a beamforming vector can be designed to fulfil different purposes. One purpose is to maximize received signal power. Another purpose is to minimize inter-layer interference. A yet further purpose it to minimize inter-cell interference. These objectives all strive to maximize the signal-to-interference-plus-noise ratio (SINR) at the UEs in the network to support high data rates, coverage, and capacity.

Different techniques for interference-aware transmission can be applied at the NNs to limit the inter-cell interference during transmit beamforming. Interference-aware transmission could potentially mitigate the overall amount of interference between cells, and hence provide performance gains. However, most techniques for interference-aware transmission are computationally demanding. This could prevent interference-aware transmission to be implemented, thus leading to scenarios where possible performance advantages, such as high data rates, coverage, and capacity, cannot be achieved.

Hence, there is a need for interference-aware transmission techniques with reduced computational complexity.

### SUMMARY

An object of embodiments herein is to address the above issues.

One particular object is to provide interference-aware transmission with comparatively low computational complexity.

According to a first aspect there is presented a method for downlink interference suppression in an access network. The method is performed by a network node. The method comprises estimating an uplink inter-cell interference covariance matrix R for UEs not served by the network node from signals as received from the UEs on a first set of antenna ports and for a selected mapping from the first set of antenna ports to a second set of antenna ports upon which the inter-cell interference covariance matrix R is formed. The method comprises performing downlink interference suppression by using a precoder P. The precoder P is determined as a function of the inter-cell interference covariance matrix R whilst treating the inter-cell interference covariance matrix R as having a block-diagonal structure, R=diag(R₁, . . . , R_{L}) with L>1 blocks.

According to a second aspect there is presented a network node for downlink interference suppression in an access network, the network node comprising processing circuitry. The processing circuitry is configured to cause the network node to estimate an uplink inter-cell interference covariance matrix R for UEs not served by the network node from signals as received from the UEs a first set of antenna ports and for a selected mapping from the first set of antenna ports to a second set of antenna ports upon which the inter-cell interference covariance matrix R is formed. The processing circuitry is configured to cause the network node to perform downlink interference suppression by using a precoder P. The precoder P is determined as a function of the inter-cell interference covariance matrix R whilst treating the inter-cell interference covariance matrix R as having a block-diagonal structure, R=diag(R₁, . . . , R_{L}) with L>1 blocks.

According to a third aspect there is presented a network node for downlink interference suppression in an access network. The network node comprises an estimate module configured to estimate an uplink inter-cell interference covariance matrix R for UEs not served by the network node from signals as received from the UEs on a first set of antenna ports and for a selected mapping from the first set of antenna ports to a second set of antenna ports upon which the inter-cell interference covariance matrix R is formed. The network node comprises an interference suppression module configured to perform downlink interference suppression by using a precoder P. The precoder P is determined as a function of the inter-cell interference covariance matrix R whilst treating the inter-cell interference covariance matrix R as having a block-diagonal structure, R=diag(R₁, . . . , R_{L}) with L>1 blocks.

According to a fourth aspect there is presented a computer program for downlink interference suppression in an access network. The computer program comprises computer code which, when run on processing circuitry of a network node, causes the network node to perform actions. One action comprises the network node to estimate an uplink inter-cell interference covariance matrix R for UEs not served by the network node from signals as received from the UEs on a first set of antenna ports and for a selected mapping from the first set of antenna ports to a second set of antenna ports upon which the inter-cell interference covariance matrix R is formed. One action comprises the network node to perform downlink interference suppression by using a precoder P. The precoder P is determined as a function of the inter-cell interference covariance matrix R whilst treating the inter-cell interference covariance matrix R as having a block-diagonal structure, R=diag(R₁, . . . , R_{L}) with L>1 blocks.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide computationally efficient interference-aware transmission.

Advantageously, by means of requiring comparatively low computational complexity for implementation and operation, the proposed method and network node for downlink interference suppression in an access network can be implemented at a comparatively low hardware cost and operated with a comparatively low energy consumption.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating an access network according to embodiments;

FIG. 2 is a flowchart of methods according to embodiments;

FIG. 3 schematically illustrates an antenna array according to embodiments;

FIG. 4 is a schematic diagram showing functional units of a network node according to an embodiment;

FIG. 5 is a schematic diagram showing functional modules of a network node according to an embodiment; and

FIG. 6 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

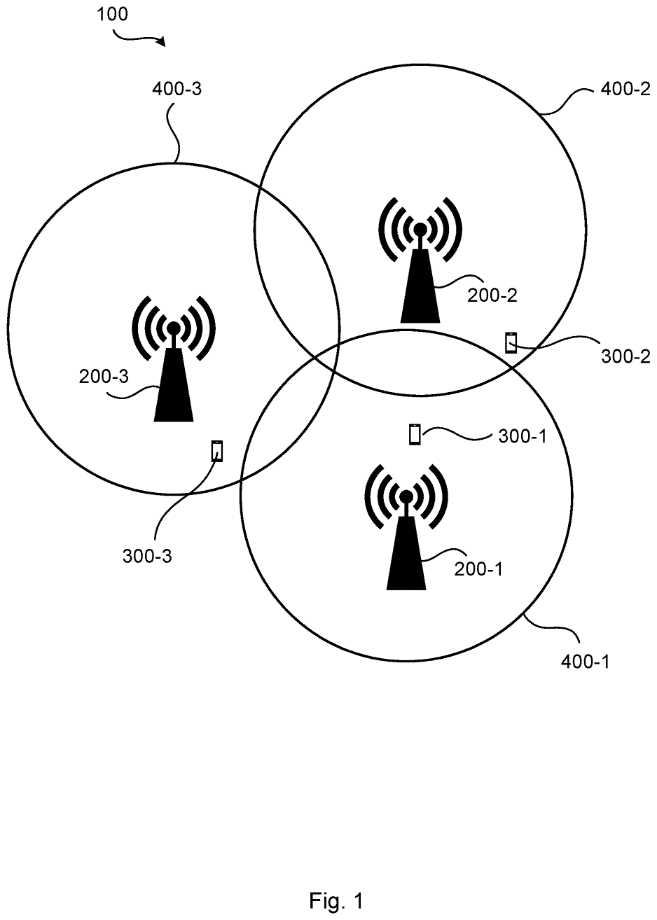

FIG. 1 is a schematic diagram illustrating an access network 100 where embodiments presented herein can be applied. The access network 100 comprises network nodes 200-1, 200-2, 200-3. Each of network nodes 200-1, 200-2, 200-3 provides network access to users, as represented by UE 300-1, 300-2, 300-3, in a respective cell 400-1, 400-2, 400-3. The access network 100 thus represents a scenario with three cells and one user is served in each cell. Each of the network nodes 200-1, 200-2, 200-3 could be any of a radio access network node, radio base station, base transceiver station, node B (NB), evolved node B (eNB), gNB, access point, access node, transmission and reception point, integrated access and backhaul (IAB) node, etc. Each of the UEs 300-1, 300-2, 300-3 could be any of a portable wireless device, mobile station, mobile phone, handset, wireless local loop phone, user equipment (UE), smartphone, laptop computer, tablet computer, wireless modem, wireless sensor device, network connectable vehicle, etc. In some examples each cell 400-1, 400-2, 400-3 is a macro cell. In some examples, one or more of the cells 400-1, 400-2, 400-3 is a small cell, such as a micro cell or a pico cell. The herein disclosed embodiments are not limited to any particular type of cells 400-1, 400-2, 400-3.

In some aspects, the interference-aware transmission is based on uplink reference signals, such as sounding reference signals (SRSs) or other types of uplink reference, control, or data signals, as transmitted by the UEs 300-1, 300-2, 300-3, possibly upon request from the network nodes 200-1, 200-2, 200-3. Special time-frequency resources are available for SRS. In the frequency domain, several SRS transmission combs (e.g., specifying which subcarriers, frequency resource units, etc. to use) are available. Also, an SRS allocation can be wideband, or sub-band down to 4 resource 30 blocks (of 12 subcarriers each). In the time domain, SRS may be transmitted in certain slots in a time-division duplex (TDD) pattern, and in certain orthogonal frequency division multiplexing (OFDM) symbols within such slots.

The SRS resources (i.e., the combs and symbols) are reused between the cells 400-1, 400-2, 400-3 and the received signal on an SRS resource at a network node 200-1, 200-2, 200-3 can, in general, be composed of a mixture of signals sent from UEs both located within the own cell and from UEs located within other cells.

Taking network node 200-1 as an example, if each user is transmitting an uplink reference signal, with power adaptation target proportional to the path loss to the serving network node, UEs 300-2, 300-3 will be visible for network node 200-1 and hence benefit from interference-aware transmission as performed by network node 200-1. This is the case since UEs 300-2, 300-3 are far from its respective serving network node 200-2, 200-3 and therefore, according to the power adaptation target, uses a high output power.

The contributions from the UEs within the own cell can be identified using channel estimation. The contributions from the UEs within the own cell can thereby be subtracted from the received signal, such that a residual signal is formed. This residual signal thus contains the spatial signatures of UEs in other cells that may be interfered during subsequent downlink (DL) transmissions. According to interference-aware transmission techniques, these spatial signatures can be analyzed so that DL transmissions can be actively and purposely avoided in the directions of the UEs in the other cells. This at least reduces the risk of the network nodes causing inter-cell interference when transmitting in the DL.

However, as noted above there is a need for interference-aware transmission techniques with reduced computational complexity.

In general terms, the interference-aware transmission techniques are based on computation of an inter-cell interference covariance matrix R. Particularly, operations relating to any of estimation, inversion, and application of the inter-cell interference covariance matrix R can be very computationally demanding. With regards to estimation, the inter-cell interference covariance matrix R can, in general terms, be estimated as:

$$R = {\sum }_{i} {r}_{i} {r}_{i}^{H} ,$$

where each term rᵢ refers to a particular residual vector obtained by a network node by reception of an uplink reference signal on a given resource (such as an SRS on an SRS resource), removal of contributions from UEs in the own cell, and extraction of a single resource element (subcarrier). Let R̅=R^{T}. Then the inverse R̅⁻¹ needs to be calculated by means of matrix inversion. With regards to application, the interference-aware transmission is generally based on computation of R̅⁻¹H^{H} by means of matrix multiplication, where H is a channel matrix representing the propagation channel from the network node to one of the UEs for SU-MIMO, or the combined propagation channel from the network node to multiple UEs for MU-MIMO. Instead of separate inversion and application, the factor R̅⁻¹H^{H} can be directly computed by solving a linear equation system. All these operations are computationally demanding.

The embodiments disclosed herein therefore relate to techniques for downlink interference suppression in an access network 100. In order to obtain such techniques there is provided a network node 200-1, a method performed by the network node 200-1, a computer program product comprising code, for example in the form of a computer program, that when run on a network node 200-1, causes the network node 200-1 to perform the method.

At least some of the herein disclosed embodiments exploit a block-diagonal structure of inter-cell interference covariance matrices obtained from the residual signals in the uplink and used for downlink interference suppression. The block-diagonalization is carried out in an appropriate orthonormal basis—for example a particular enumeration, or permutation, or linear transformation, of antenna elements in the antenna arrays used by the network nodes 200-1, 200-2, 200-3—in which neglecting off-diagonal blocks only has a minor impact on downlink performance.

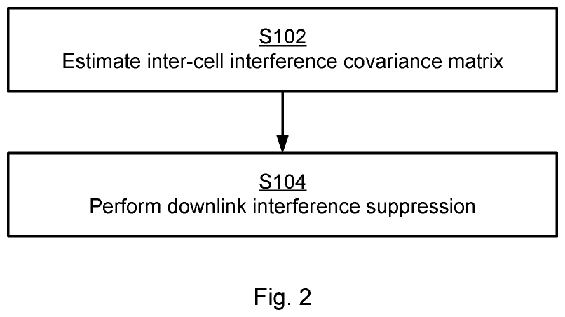

FIG. 2 is a flowchart illustrating embodiments of methods for downlink interference suppression in an access network 100. The methods are performed by the network node 200-1. The methods are advantageously provided as computer programs 720.

At least some of the UEs 300-1, 300-2, 300-3 served in the access network 100 are instructed, by their respective serving network nodes 200-1, 200-2, 200-3, to transmit signals for all, or at least some, of the network nodes 200-1, 200-2, 200-3 to measure on. The network node 200-1 is therefore assumed to receive these signals.

S102: The network node 200-1 estimates an uplink inter-cell interference covariance matrix R for UEs 300-2, 300-3 not served by the network node 200-1. The inter-cell interference covariance matrix is estimated from signals as received from the UEs 300-2, 300-3 on a first set of antenna ports and for a selected mapping from the first set of antenna ports to a second set of antenna ports upon which the inter-cell interference covariance matrix R is formed.

Here, the interference covariance matrix R can be estimated based on some interference measurement resources. These interference measurement resources could contain reference signals but could also contain data signals or control signals as sent by UEs 300-2, 300-3 not served by the network node 200-1. As will be further disclosed below, in case also signals from UEs 300-1 served by the network node 200-1 are received on the interference measurement resources, then the contribution of such signals is removed. Then, what remains on the interference measurement resources are signals coming from the UEs 300-2, 300-3 in other cells from which the uplink inter-cell interference covariance matrix R is estimated.

In one example, the interference covariance matrix R is estimated either in a first basis and then transformed using the selected mapping. In another example, first the received signals are transformed using the selected mapping and then the interference covariance matrix R is estimated from the thus transformed received signals.

S104: The network node 200-1 performs downlink interference suppression by using a precoder P. The precoder P is determined as a function of the inter-cell interference covariance matrix R whilst treating the inter-cell interference covariance matrix R as having a block-diagonal structure, R=diag(R₁, . . . , R_{L}) with L>1 blocks.

Embodiments relating to further details of downlink interference suppression in an access network 100 as performed by the network node 200-1 will now be disclosed.

There could be different ways to select the mapping from the first set of antenna ports to the second set of antenna ports. In general terms, the mapping could be a combination of a permutation of antenna ports and a linear transformation. The linear transformation could correspond to the application of two-dimensional (2D) Discrete Fourier Transforms (DFT) on groups of antenna ports (i.e., a block diagonal structure of the linear transformation matrix). In some embodiments, the mapping is selected with an objective to give the inter-cell interference covariance matrix R the block-diagonal structure. In this respect, it is understood that the true inter-cell interference covariance matrix will never be completely block-diagonal. In some examples, the inter-cell interference matrix itself is thus not strictly block-diagonal, but contains a few off-diagonal blocks of importance as well, or for example has a tri-block-diagonal structure to capture correlations between adjacent diagonal blocks. However, in some embodiments, the inter-cell interference covariance matrix R is treated as having the block-diagonal structure when being estimated. Further, the inter-cell interference covariance matrices might comprise a thermal noise term from the estimation in the uplink, and also have an added scaled identity matrix for regularization.

There could be different types of signals that are transmitted by the UEs 300-2, 300-3 not served by the network node 200-1. In some examples, the signals are SRSs that are transmitted by the UEs 300-1, 300-2, 300-3 on certain SRS resources. Each such SRS resource might define a frequency comb, frequency resource block, and OFDM symbol. However, in other examples, another UL signal, such as demodulation reference signals (DMRS), signals transmitted on a control channel (such as a physical uplink control channel; PUCCH) or a data channel (such as a physical uplink shared channel; PUSCH), is by the network node 200-1 treated as an uplink reference signal and thus used instead of one or more SRSs.

In some examples, each individual antenna port corresponds to a respective individual antenna element. However, in other examples, each individual antenna port corresponds to a subarray composed of two or more antenna elements (that cannot be directly measured on and/or controlled in baseband processing).

In some embodiments, the signals are received together with uplink reference signals from UEs 300-1 served by the network node 200-1, where contributions from the uplink reference signals received from the UEs 300-1 for which channel estimation has been performed by the network node 200-1 is removed when determining the inter-cell interference covariance matrix R. In general terms, the signals from UEs 300-1 might be mixed with those from UEs 300-2 and 300-3. Therefore, the process of removing the contributions from UEs 300-1 might require channel estimation and then subtraction of the estimated contributions from UEs 300-1.

In some embodiments, the signals are received as at least two uplink reference signal resources, and where the inter-cell interference covariance matrix R is estimated as a combination of at least two inter-cell interference covariance matrices, one for each of the at least two uplink reference signal resources. Here, the combination might be implemented as a weighted sum of the at least two inter-cell interference covariance matrices. These at least two inter-cell interference covariance matrices might have been estimated for different time windows, combs, and/or for different parts of the frequency band.

In general terms, the inter-cell interference covariance matrix R can be treated as having a block-diagonal structure during one or more of the above-noted operations involving estimation, inversion, and/or application of the inter-cell interference covariance matrix R. Treating the inter-cell interference covariance matrix R as having a block-diagonal structure, i.e., with R=diag(R₁, . . . , R_{L}), enables the computational demands for the precoder determination to be reduced. In some examples, the computational demands can be reduced as follows.

With further regards to estimation, in some examples, the inter-cell interference covariance matrix R can be estimated as:

$$R = diag ( {R}_{1} , … , {R}_{L} ) = diag ( {\sum }_{i} {r}_{1 , i} {r}_{1 , i}^{H} , … , {\sum }_{i} {r}_{L , i} {r}_{L , i}^{H} )$$

where

$${r}_{i}^{T} = [ {r}_{1 , i}^{T} , … , {r}_{L , i}^{T} ] ,$$

where rᵢ is a residual vector representing the i:th sample of an uplink reference signal resource.

With regards to inversion, the inverse R⁻¹, of the inter-cell interference covariance matrix R can be calculated as follows:

$${R}^{- 1} = diag ( {R}_{1}^{- 1} , … , {R}_{L}^{- 1} ) .$$

With regards to application, in some embodiments, the calculation of the precoder P involves implementing an operation corresponding to multiplication of a channel matrix H representing a channel between the network node and at least one UE 300-1 served by the network node 200-1 with an inverse of the transpose of the inter-cell interference covariance matrix R, i.e., with R̅⁻¹, as divided into the L>1 blocks in accordance with the block-diagonal structure. Further, R̅ could be regularized. In some examples, the calculation of the precoder P involves decomposing the calculation into L>1 operations, each operation only involving one of the L>1 blocks as derived from the inter-cell interference covariance matrix R. In some examples, this one block corresponds to a common matrix block R derived from the inter-cell interference covariance matrix R. In some examples, this one block corresponds to each individual block R₁, . . . , R_{L} from the inter-cell interference covariance matrix R.

In further detail, in some embodiments, calculating the precoder P involves computation of a term R̅⁻¹H^{H}, where H is a channel matrix that represents a channel between the network node and at least one UE 300-1 served by the network node 200-1. Then, in some examples, the term R̅⁻¹H^{H} can be calculated according to:

$${\overline{R}}^{- 1} {H}^{H} = {[ {H}_{1} {\overline{R}}_{1}^{- 1} , … , {H}_{L} {\overline{R}}_{L}^{- 1} ]}^{H} ,$$

where H=[H₁, . . . , H_{L}]. Since the inter-cell interference covariance matrix R has a block-diagonal structure, the same applies to R and R⁻¹. Therefore, the precoder P can be determined with reduced complexity during the matrix multiplication between the channel matrix H (actually, H^{H}) and the inter-cell interference covariance matrix R (actually, R̅⁻¹). In some examples, the multiplication R̅⁻¹H^{H} is, equivalently, carried out by solving a corresponding equation system. The decomposition into separate blocks would lead to L such linear equation systems that can be solved separately,

Alternatively, with regards to joint inversion and application, each factor

$${H}_{l} {\overline{R}}_{l}^{- 1} ,$$

for l=1 . . . , L, can be calculated by solving a respective linear equation system.

Further, in some examples, all blocks in the inter-cell interference covariance matrix R are assumed to be equal to \tilde{R}. That is, in some examples, all Rₗ are equal, such that R₁= . . . =R_{L}=\tilde{R}. In this way, the inter-cell interference covariance matrix R can be expressed as R=diag(\tilde{R}, . . . , \tilde{R})=1⊗\tilde{R}, where ⊗ denotes the Kronecker product operator. Assuming the inter-cell interference covariance matrix R to be composed of common blocks \tilde{R} can make the estimation more robust due to the availability of having more samples as

$$\tilde{R} = \frac{1}{L} {\sum }_{l = 1}^{L} {\sum }_{i} {r}_{l , i} {r}_{l , i}^{H}$$

and only one single inversion \tilde{R}→\tilde{R}⁻¹ needs to be performed. Alternatively, with regards to joint inversion and application, the factors HₗR⁻¹, for l=1 . . . , L, can be calculated by solving different linear equation systems using a single matrix decomposition of the common matrix \tilde{R}.

There could be different ways to calculate the precoder P using the inter-cell interference covariance matrix R and based on the channel matrix H.

In some examples, the precoder P is defined as a precoder matrix composed of beamforming vectors as columns. Different power scaling of the columns can be applied during downlink transmission.

In some examples, the precoder P is calculated according to:

$$P = {( {H}^{H} H + \overline{R} )}^{- 1} {H}^{H} = {\overline{R}}^{- 1} {{H}^{H} ( H {\overline{R}}^{- 1} {H}^{H} + I )}^{- 1}$$

where R̅=R^{T}, where H is the channel matrix that represents the channel between the network node and at least one UE 300-1 served by the network node 200-1, where X⁻¹ represents inverse of matrix X, where Y^{H} represents Hermitian transpose of matrix Y, and where I is an identity matrix. Hence, in some examples, calculating the precoder P involves converting the inter-cell interference covariance matrix R to R̅=R^{T}, where R̅=R^{T} can be interpreted as representing a downlink transmit correlation matrix for potentially interfering channels. Further, in some examples, calculating the precoder P involves performing a matrix multiplication of the channel matrix H with the inverse of R̅. This matrix multiplication can be performed in the same manner as disclosed above for the computation of the term the term R̅⁻¹H^{H}, i.e., to divide the computation into L parts, each corresponding to matrix multiplication of a block Hₗ with a block

$${\overline{R}}_{l}^{- 1} .$$

In general terms, the downlink interference suppression might involve beamforming towards UEs 300-1 served by the network node 200-1 and null-forming towards the UEs 300-2, 300-3 not served by the network node 200-1. In some aspects, joint transmission is performed from a cluster of several network nodes 200-1, 200-2 in the sense that beamforming vectors from the network nodes 200-1, 200-2 in the cluster are jointly determined. Hence, in some embodiments, less than all of the antenna ports belong to the network node 200-1 and the remaining antenna ports belong to at least one other network node 200-2. The inter-cell interference covariance matrix R would then span across all antenna ports of all network nodes 200-1, 200-2 in the cluster. A basis can then be selected that admits forming blocks of antenna ports, where each block of antenna ports represents antenna elements belonging to one respective network node, thereby disregarding any correlations across network nodes 200-1, 200-2. Interference suppression can then be performed to UEs 300-3 served by network nodes 200-3 outside the cluster.

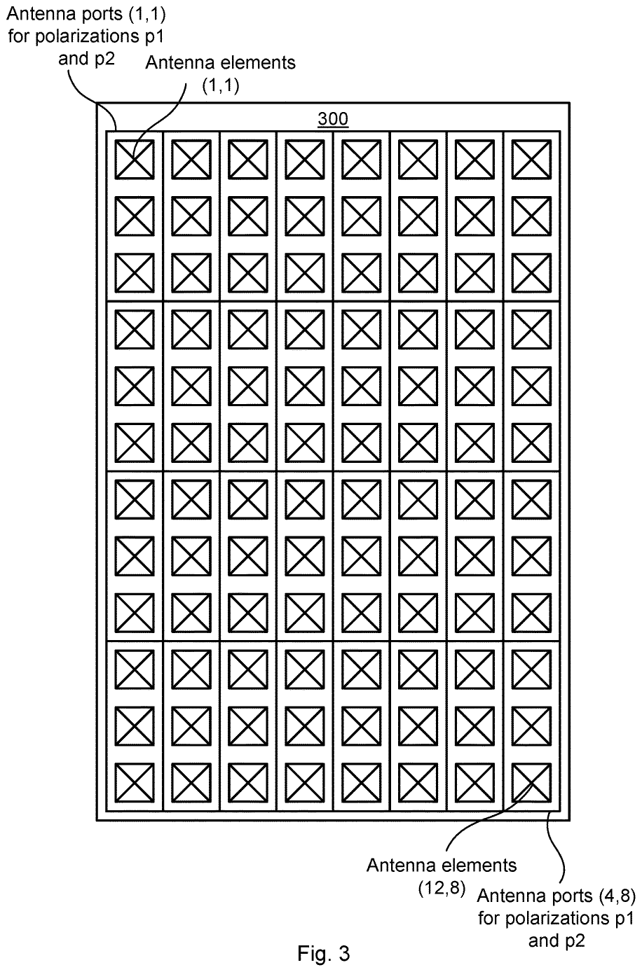

When introducing a block-diagonal structure, it can be of importance of how the antenna elements are enumerated. Consider a 2D dual-polarized antenna array 300 as in FIG. 3 with N rows, and M columns (not taking polarization into account). At each position in the N-by-M there are two antenna ports of different polarization on the same position. In the example of FIG. 3, the antenna has N=4 rows, M=8 columns of antenna ports, and each antenna port corresponds to a vertical 3-by-1 subarray of antenna elements of the same polarization. Thus, for each position in the 4-by-8 grid there are two co-located antenna ports (or subarrays) of different polarization. Hence, in some examples, the antenna ports are provided in rows and columns of an antenna 300 having N rows and M columns of antenna ports, for some integers M, N>1, where each antenna port has a polarization. The antenna ports are provided in either antenna space or beam space of the antenna 300. The beam space is defined by applying 2D DFT on the signals from the antenna subarrays. A consistent antenna element enumeration is assumed for the 2MN elements of the residual vectors rₗ, the 2MN columns of the channel matrix H, as well as the 2MN rows and columns of the inter-cell interference covariance matrix R. In general terms, the antenna ports are provided in antenna space or beam space. Beam space here refers to that, for example, 2D DFT is applied, separately for each polarization, to the signals from the antenna (or antenna subarrays). Without loss of generality, antenna space will be used as an example hereinafter, but any reference to rows or columns of the antenna (i.e., in antenna space) could likewise also refer to the beam space. The number of blocks L and the blocks themselves in the inter-cell interference covariance matrix R can then be selected as follows based on the mapping from the first set of antenna ports to a second set of antenna ports R, where each example represents one antenna element enumeration for asserting a block-diagonal structure of the inter-cell interference covariance matrix, that is, R=diag(R₁, . . . , R_{L}):
L=2 blocks, each of size MN×MN, with each block belonging to different polarizations,
L=2N blocks, each of size M×M, with each block belonging to different polarizations and rows of the antenna space or elevation beams of the beam space of the antenna 300,
L=N blocks, each of size 2M×2M, with each block belonging to different rows of the antenna space or elevation beams of the beam space of the antenna 300,
L=2M blocks, each of size N×N, with each block belonging to different polarizations and columns of the antenna space or azimuth beams of the beam space of the antenna 300,
L=M blocks, each of size 2N×2N, with each block belonging to different columns of the antenna space or azimuth beams of the beam space of the antenna 300,
L=2N/A blocks, each of size MA×MA, with each block belonging to different polarizations and blocks of adjacent rows of the antenna space or elevation beams of the beam space of the antenna 300, for some integer A>1,
L=N/A blocks, each of size 2MA×2MA, with each block belonging to different blocks of adjacent rows of the antenna space or elevation beams of the beam space of the antenna 300, for some integer A>1,
L=2M/B blocks, each of size NB×NB, with each block belonging to different polarizations and blocks of adjacent columns of the antenna space or azimuth beams of the beam space of the antenna 300, for some integer B>1,
L=M/B blocks, each of size 2NB×2NB, with each block belonging to different blocks of adjacent columns of the antenna space or azimuth beams of the beam space of the antenna 300, for some integer B>1.

It is here noted that any suitable orthonormal basis can be used for inter-cell interference estimation and precoder determination. The different antenna element enumerations above correspond to special cases of simple permutations. For example, another orthonormal basis can be created by applying a 2D DFT matrix for each polarization. This converts the different “columns” above into “azimuth beams” and the different “rows” into “elevation beams”, and thus provides a conversion from the antenna space to the beam space.

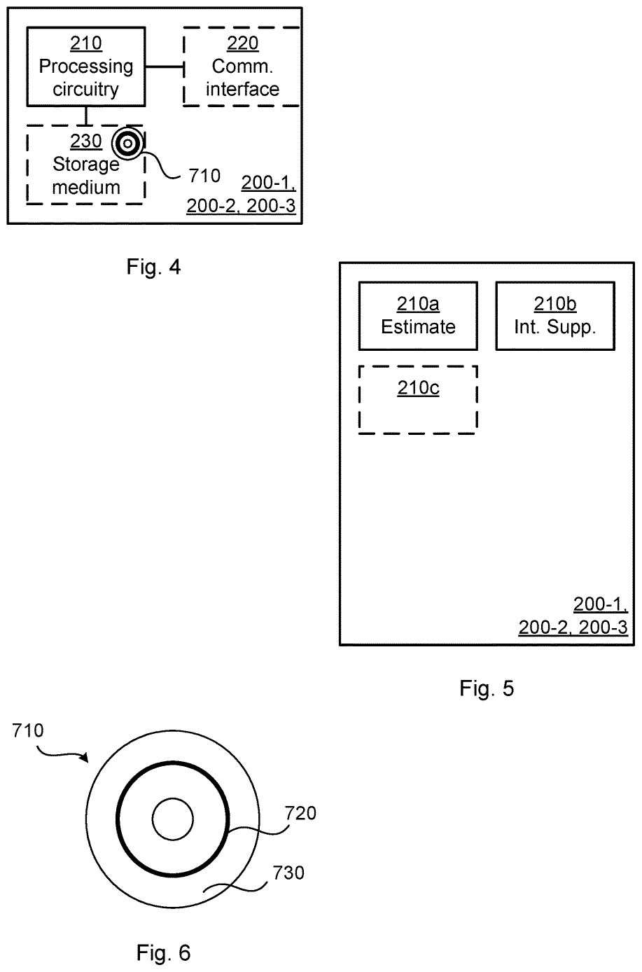

FIG. 4 schematically illustrates, in terms of a number of functional units, the components of a network node 200-1 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 710 (as in FIG. 6), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200-1 to perform a set of operations, or steps, as disclosed above. For example, the storage medium 230 may store the set of operations, and the processing circuitry 210 may be configured to retrieve the set of operations from the storage medium 230 to cause the network node 200-1 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200-1 may further comprise a communications (comm.) interface 220 at least configured for communications with other entities, functions, nodes, and devices, such as the UEs 300-1, 300-2, 300-3 as well as with other network nodes 200-2, 200-3. As such the communications interface 220 may comprise one or more transmitters and receivers, comprising analogue and digital components. The processing circuitry 210 controls the general operation of the network node 200-1 e.g. by sending data and control signals to the communications interface 220 and the storage medium 230, by receiving data and reports from the communications interface 220, and by retrieving data and instructions from the storage medium 230. Other components, as well as the related functionality, of the network node 200-1 are omitted in order not to obscure the concepts presented herein.

FIG. 5 schematically illustrates, in terms of a number of functional modules, the components of a network node 200-1 according to an embodiment. The network node 200-1 of FIG. 5 comprises a number of functional modules; an estimate module 210a configured to perform action S102, and an interference suppression (Int. Supp.) module 210b configured to perform action S104. The network node 200-1 of FIG. 5 may further comprise a number of optional functional modules, as represented by functional module 210c. In general terms, each functional module 210a: 210c may in one embodiment be implemented only in hardware and in another embodiment with the help of software, i.e., the latter embodiment having computer program instructions stored on the storage medium 230 which when run on the processing circuitry makes the network node 200-1 perform the corresponding steps mentioned above in conjunction with FIG. 6. It should also be mentioned that even though the modules correspond to parts of a computer program, they do not need to be separate modules therein, but the way in which they are implemented in software is dependent on the programming language used. Preferably, one or more or all functional modules 210a: 210c may be implemented by the processing circuitry 210, possibly in cooperation with the communications interface 220 and/or the storage medium 230. The processing circuitry 210 may thus be configured to from the storage medium 230 fetch instructions as provided by a functional module 210a: 210c and to execute these instructions, thereby performing any steps as disclosed herein.

The network node 200-1 may be provided as a standalone device or as a part of at least one further device. For example, the network node 200-1 may be provided in a node of the radio access network or in a node of the core network. Alternatively, functionality of the network node 200-1 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200-1 may be executed in a first device, and a second portion of the of the instructions performed by the network node 200-1 may be executed in a second device; the herein disclosed embodiments are not limited to any particular number of devices on which the instructions performed by the network node 200-1 may be executed. Hence, the methods according to the herein disclosed embodiments are suitable to be performed by a network node 200-1 residing in a cloud computational environment. Therefore, although a single processing circuitry 210 is illustrated in FIG. 4 the processing circuitry 210 may be distributed among a plurality of devices, or nodes. The same applies to the functional modules 210a: 210c of FIG. 5 and the computer program 720 of FIG. 6.

Some (radio) access network architectures define network nodes comprising multiple component parts or nodes: a central unit (CU), one or more distributed units (DUs), and one or more radio units (RUs). The protocol layer stack of the network node is divided between the CU, the DUs and the RUs, with one or more lower layers of the stack implemented in the RUs, and one or more higher layers of the stack implemented in the CU and/or DUs. The CU is coupled to the DUs via a fronthaul higher layer split (HLS) network; the CU/DUs are connected to the RUs via a fronthaul lower-layer split (LLS) network. The DU may be combined with the CU in some embodiments, where a combined DU/CU may be referred to as a CU or simply a baseband unit. A communication link for communication of user data messages or packets between the RU and the baseband unit, CU, or DU is referred to as a fronthaul network or interface. Messages or packets may be transmitted from the network node 200 in the downlink (i.e., from the CU to the RU) or received by the network node 200 in the uplink (i.e., from the RU to the CU).

FIG. 6 shows one example of a computer program product 710 comprising computer readable storage medium 730. On this computer readable storage medium 730, a computer program 720 can be stored, which computer program 720 can cause the processing circuitry 210 and thereto operatively coupled entities and devices, such as the communications interface 220 and the storage medium 230, to execute methods according to embodiments described herein. The computer program 720 and/or computer program product 710 may thus provide means for performing any steps as herein disclosed.

In the example of FIG. 6, the computer program product 710 is illustrated as an optical disc, such as a CD (compact disc) or a DVD (digital versatile disc) or a Blu-Ray disc. The computer program product 710 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 720 is here schematically shown as a track on the depicted optical disk, the computer program 720 can be stored in any way which is suitable for the computer program product 710.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for downlink interference suppression in an access network, wherein the method is performed by a network node, and the method comprises:
estimating an uplink inter-cell interference covariance matrix R for UEs not served by the network node from signals as received from the UEs on a first set of antenna ports and for a selected mapping from the first set of antenna ports to a second set of antenna ports upon which the inter-cell interference covariance matrix R is formed; and
performing downlink interference suppression by using a precoder P, wherein the precoder P is determined as a function of the inter-cell interference covariance matrix R whilst treating the inter-cell interference covariance matrix R as having a block-diagonal structure, R=diag(R₁, . . . , R_{L}) with L>1 blocks.

2. The method of claim 1, wherein the mapping is selected with an objective to give the inter-cell interference covariance matrix R the block-diagonal structure.

3. The method of claim 1, wherein the signals are received together with uplink reference signals from UEs served by the network node, and wherein any contribution from the uplink reference signals received from the UEs for which channel estimation has been performed by the network node is removed when determining the inter-cell interference covariance matrix R.

4. The method of claim 1, wherein signals are received as at least two uplink reference signal resources, and wherein the inter-cell interference covariance matrix R is estimated as a combination of at least two inter-cell interference covariance matrices, one for each of the at least two uplink reference signal resources.

5. The method of claim 1, wherein the inter-cell interference covariance matrix R is treated as having the block-diagonal structure when being estimated.

6. The method of claim 1, wherein the inter-cell interference covariance matrix R is estimated as:
$$R = diag ( {R}_{1} , … , {R}_{L} ) = diag ( {\sum }_{i} {r}_{1 , i} {r}_{1 , i}^{H} , … , {\sum }_{i} {r}_{L , i} {r}_{L , i}^{H} )$$
where
$${r}_{i}^{T} = [ {r}_{1 , i}^{T} , … , {r}_{L , i}^{T} ] ,$$
where rᵢ is a residual vector representing the i:th sample of an uplink signal resource.

7. The method of claim 1, wherein all Rₗ are equal, such that R₁= . . . =R_{L}=\tilde{R}.

8. The method of claim 7, wherein \tilde{R} is calculated according to:
$$\tilde{R} = \frac{1}{L} {\sum }_{l = 1}^{L} {\sum }_{i} {r}_{l , i} {r}_{l , i}^{H} .$$

9. The method of claim 1, wherein
the antenna ports are provided in rows and columns of an antenna having N rows and M columns, for some integers M, N>1,
the antenna ports are provided in either antenna space or beam space of the antenna,
each antenna port has a polarization, and
the number of blocks L and the blocks themselves in the inter-cell interference covariance matrix R are selected as follows based on the mapping from the first set of antenna ports to a second set of antenna ports:
L=2 blocks, each of size MN×MN, with each block belonging to different polarizations,
L=2N blocks, each of size M× M, with each block belonging to different polarizations and rows of the antenna space or elevation beams of the beam space of the antenna,
L=N blocks, each of size 2M×2M, with each block belonging to different rows of the antenna space or elevation beams of the beam space of the antenna,
L=2M blocks, each of size N×N, with each block belonging to different polarizations and columns of the antenna space or azimuth beams of the beam space of the antenna,
L=M blocks, each of size 2N×2N, with each block belonging to different columns of the antenna space or azimuth beams of the beam space of the antenna,
L=2N/A blocks, each of size MA×MA, with each block belonging to different polarizations and blocks of adjacent rows of the antenna space or elevation beams of the beam space of the antenna, for some integer A>1,
L=N/A blocks, each of size 2MA×2MA, with each block belonging to different blocks of adjacent rows of the antenna space or elevation beams of the beam space of the antenna, for some integer A>1,
L=2M/B blocks, each of size NB× NB, with each block belonging to different polarizations and blocks of adjacent columns of the antenna space or azimuth beams of the beam space of the antenna, for some integer B>1,
L=M/B blocks, each of size 2NB×2NB, with each block belonging to different blocks of adjacent columns of the antenna space or azimuth beams of the beam space of the antenna, for some integer B>1.

10. The method of claim 1, wherein calculation of the precoder P involves implementing an operation corresponding to multiplication of a channel matrix H representing a channel between the network node and at least one UE served by the network node with an inverse of a transpose of the inter-cell interference covariance matrix R as divided into the L>1 blocks in accordance with the block-diagonal structure.

11. The method of claim 10, wherein the calculation of the precoder P involves decomposing the calculation into L>1 operations, each operation only involving one of the L>1 blocks as derived from the inter-cell interference covariance matrix R.

12. The method of claim 11, wherein said one block corresponds to a common matrix block \tilde{R} derived from the inter-cell interference covariance matrix R.

13. The method of claim 1, wherein said one block corresponds to each individual block R₁, . . . , R_{L} from the inter-cell interference covariance matrix R.

14. The method of claim 1, wherein calculating the precoder P involves computation of a term R̅⁻¹H^{H}, where R̅=R^{T}, where H is a channel matrix that represents a channel between the network node and at least one UE served by the network node, and wherein R̅⁻¹H^{H} is calculated according to:
$${\overline{R}}^{- 1} {H}^{H} = {[ {H}_{1} {\overline{R}}_{1}^{- 1} , … , {H}_{L} {\overline{R}}_{L}^{- 1} ]}^{H} , where H = [ {H}_{1} , … , {H}_{L} ] .$$

15. The method of claim 1, wherein the precoder P is calculated according to:
$$P = {( {H}^{H} H + \overline{R} )}^{- 1} {H}^{H} = {\overline{R}}^{- 1} {{H}^{H} ( H {\overline{R}}^{- 1} {H}^{H} + I )}^{- 1}$$
where R̅=R^{T}, where H is a channel matrix that represents a channel between the network node and at least one UE served by the network node, where X^{T} represents transpose of matrix X, where X⁻¹ represents inverse of matrix X, where Y^{H} represents Hermitian transpose of matrix Y, and where I is an identity matrix.

16. The method of claim 15, wherein each factor
$${H}_{l} {\overline{R}}_{l}^{- 1} ,$$
for l=1 . . . , L, is calculated by solving a respective linear equation system.

17. The method of claim 1, wherein the downlink interference suppression involves beamforming towards UEs served by the network node- and null-forming towards the UEs not served by the network node.

18. The method of claim 1, wherein less than all of the antenna ports belong to the network node and the remaining antenna ports belong to at least one other network node.

19. A network node for downlink interference suppression in an access network, the network node comprising:
memory; and
processing circuitry, wherein the network node is configured to:
estimate an uplink inter-cell interference covariance matrix R for UEs not served by the network node from signals as received from the UEs on a first set of antenna ports and for a selected mapping from the first set of antenna ports to a second set of antenna ports upon which the inter-cell interference covariance matrix R is formed; and
perform downlink interference suppression by using a precoder P, wherein the precoder P is determined as a function of the inter-cell interference covariance matrix R whilst treating the inter-cell interference covariance matrix R as having a block-diagonal structure, R=diag(R₁, . . . , R_{L}) with L>1 blocks.

20-22. (canceled)

23. A non-transitory computer readable storge medium storing a computer program for configuring a network node to perform the method of claim 1.
